(19) United States
(12) Patent Application Publication
(10) Pub. No.: US 2020/0392999 A1
(43) Pub. Date: Dec. 17, 2020

(54) WHEEL BEARING ARRANGEMENT HAVING A ROTATIONAL AXIS

(71) Applicant: Schaeffler Technologies AG & Co. KG, Herzogenaurach (DE)

(72) Inventors: Alexander Häpp, Hofheim/Lendershausen (DE); Marco Krapf, Burkardroth (DE); Ringo Koepke, Schweinfurt (DE); Andreas Becker, Fuchsstadt (DE)

(73) Assignee: Schaeffler Technologies AG & Co. KG, Herzogenaurach (DE)

(21) Appl. No.: 16/968,341

(22) PCT Filed: Jan. 29, 2019
(86) PCT No.: PCT/DE2019/100094

§ 371 Date: Aug. 7, 2020

(30) Foreign Application Priority Data
Feb. 13, 2018 (DE) 10 2018 103 109.2

(51) Int. Cl. F16C 33/78; F16C 19/18; F16C 33/80

(52) U.S. Cl. CPC F16C 33/7883; F16C 2326/02; F16C 33/80; F16C 19/184

(57) ABSTRACT

A wheel bearing arrangement having a rotational axis, having at least an outer ring; an inner ring which can be rotated about the rotational axis relative to the outer ring; and a bearing seal arrangement which comprises a running ring which is configured as an outer seal and a seal body which is configured as a main seal, wherein the running ring is supported on the inner ring and the seal body is supported on the outer ring, wherein the running ring is of C-shaped configuration in cross section with a radial and axial extent with a side which is open towards the rolling bodies.

### CROSS-REFERENCE TO RELATED APPLICATIONS

This application is the U.S. National Phase of PCT Appln. No. PCT/DE2019/100094 filed Jan. 29, 2019, which claims priority to DE 10 2018 103 109.2 filed Feb. 13, 2018, the entire disclosures of which are incorporated by reference herein.

### TECHNICAL FIELD

The disclosure relates to a wheel bearing arrangement having a rotational axis, for example for a wheel bearing of a motor vehicle, preferably a driven axis.

Wheel bearing arrangements for motor vehicles are known from the state of the art in which lubricants and appropriate seals to the environment are used to achieve a long service life in the rolling bearings to protect them against, for example, dirt particles and spray water. An advantageous embodiment is shown in DE 10 2013 218 635 A1. In this case, a centrifugal plate is provided which, in combination with sealing lips and a wheel flange, forms an effective sealing labyrinth. A sealing compound is preferably provided between the centrifugal plate and the wheel flange to prevent contaminants from penetrating through the gap between the centrifugal plate and the inner ring. In addition, the centrifugal plate forms a radially outward collecting space for keeping contaminants away.

A disadvantage of the embodiment of the centrifugal plate shown there is the relatively complex shape. This stands in the way of a cost-effective production.

Furthermore, a wheel bearing arrangement is known from KR 10-1 509 165, in which a C-shaped plate is formed to form a sealing bearing for a sealing body. The C-shaped plate is arranged axially between the wheel flange and the outer ring. As a result, the structure is axially long and, moreover, no collecting space is formed for keeping contaminants away. In addition, the sealing body is arranged radially on the outside of the outer ring, as a result of which the sealing effect is impaired or nullified when the outer ring is deformed.

### SUMMARY

The features of the claims can be combined in any technically sensible way, and the explanations in the following description and features from the figures, which comprise additional embodiments of the disclosure, can also be used for this purpose.

The disclosure relates to a wheel bearing arrangement comprising an axis of rotation, comprising at least the following components:

an outer ring;

an inner ring which can be rotated about the rotational axis relative to the outer ring, a bearing inner chamber being formed between the outer ring and the inner ring, in which rolling bodies are arranged such that they can roll;

a wheel flange which is connected fixedly to the inner ring so as to rotate therewith, the wheel flange overlapping the bearing inner chamber radially; and

a bearing seal arrangement, which comprises a running ring which is configured an outer seal and a seal body which is configured as a main seal, wherein the running ring being supported on the inner ring and the seal body being supported on the outer ring.

The wheel bearing arrangement is characterized in particular by the fact that the running ring is designed to be C-shaped in cross-section having a radial and axial extension with a side open to the rolling bodies,

wherein the running ring is radially and axially spaced from the wheel flange so that a clearance is formed between the wheel flange and the running ring along the entire radial extent of the running ring, the clearance forming a collection chamber.

In the following, if the axial direction, radial direction or the circumferential direction and corresponding terms are used without explicitly indicating otherwise, reference is made to the mentioned axis of rotation.

The wheel bearing arrangement proposed here is preferably designed to be largely conventional, so that it can be replaced, for example, in a conventional wheel bearing, i.e., without adaptations to the inner ring, the outer ring and/or the wheel flange. For example, the wheel bearing arrangement largely corresponds to the embodiment as shown in DE 10 2013 218 635 A1 cited at the outset. However, the centrifugal plate shown there is replaced by a running ring according to one embodiment according to the present description. In an advantageous embodiment, the seal assembly shown there is also replaced by a seal body according to the present description.

It should be pointed out that the wheel bearing arrangement proposed here is not limited to the application shown in DE 10 2013 218 635 A1, and can be used, for example, in a wheel bearing arrangement with a standing shaft (on the inner ring-side) and circumferential receiver (on the outer ring side). Furthermore, it should be pointed out that the wheel flange is preferably formed in one piece with the inner ring, but this is not necessary. For example, the wheel flange is set up for connecting, for example screwing, a vehicle wheel. Alternatively, such a connection or a similar connection with radial extension is created on the circumferential outer ring. The wheel flange covers and radially closes the bearing inner chamber, so that (without a bearing seal arrangement) an axial gap to the outer ring alone, that is to say a radially outward opening to the surroundings, is formed.

The inner ring and the outer ring form a bearing inner chamber in which rolling bodies are arranged in such a rolling manner that a low-friction relative rotation from the inner ring to the outer ring is made possible. A roller bearing is thus created, for example a ball bearing or cylindrical roller bearing, preferably an axially prestressable angular contact ball bearing or tapered roller bearing.

The bearing seal arrangement now includes a sealing body, for example like the sealing set mentioned at the outset, by means of which at least one sealing lip prevents lubricant from flowing out and/or dirt particles and/or splash water from penetrating. For this purpose, the sealing lip is biased radially and/or axially against a corresponding sealing surface and is therefore in frictional contact with this sealing surface. The sealing surface must therefore comprise a suitable surface roughness, roundness and (axial) flatness. The sealing surface is therefore preferably formed by the running ring. Alternatively, such a suitable sealing surface with the properties mentioned is formed on a (preferably offset partial) surface of the inner ring. The sealing body thus forms the main seal.

The running ring replacing the conventional centrifugal plate now comprises a relatively simple shape in that it forms a C. This C-shaped running ring thus comprises a total of only two wall elements of the same axial orientation. In contrast to the previously known centrifugal plate, no (axial) contact with the wheel flange is provided in use, or no (axial) contact with the radially extending portion of the wheel flange axially outside the bearing inner chamber is provided in a one-piece embodiment of the inner ring and wheel flange. Rather, the running ring is pushed onto the inner ring, preferably pressed on, by means of the inner wall element thereof on the inner ring side alone, thereby forming sufficient axial fixation and, at the same time, a static sealing seat with the inner ring.

The running ring is thus simple and reduced in cost, for example in an easy-to-implement deep-drawing process or one-step stamping process from a metal sheet. As a result of the C-shaped configuration of the running ring, in contrast to previously known solutions under customary manufacturing tolerances, the contact surface for the static sealing seat of the running ring can also be produced without being reworked, in particular without machining, for example when cold-forming a metal sheet. Due to the shape thereof, the wall element on the inner ring side for the static sealing seat in the inner ring is more robust against constrictions or deformations and can be manufactured with such precision that a high airtightness can be achieved. In contrast to the embodiment according to DE 10 2013 218 635 A1, a sealing compound between the wheel flange or the inner ring and the running ring, which is upstream of the running ring from the exit to the bearing inner chamber, is therefore not necessary because the penetration of contaminants due to the significantly improved tightness of the gap between the running ring and inner ring is already sufficiently prevented. In addition, there is a comparatively reduced material consumption in the manufacture of the running ring.

As a result of the C-shaped configuration of the running ring, in a preferred embodiment it is constructed to be radially compact so that the running ring can be arranged between the outer ring and the inner ring, that is to say in an axial extension of the bearing inner chamber. This enables an axially very compact structure of the wheel bearing arrangement. According to this embodiment, the running ring is partially, preferably completely, arranged radially within an axial projection of the outer ring and spaced in the radial direction from the outer ring. Here, the at least one sealing lip, for example for the sealing contact with the running ring, of the sealing body is axially drawn into this axial extension of the bearing inner chamber and the sealing body is thus at least partially axially arranged between the running ring and the rolling bodies, or a bearing cage which can be present for the rolling bodies under the circumstances. The at least one sealing lip preferably projects into the open side of the running ring and uses a correspondingly oriented inner surface of the C-shape as the running surface, the sealing lip being in direct contact with this running surface or a (small) gap and/or a lubricant film, for example a grease film, is formed between the sealing lip and this tread.

The running ring is arranged at a distance from the (radially extending portion of the) wheel flange(s), so that no contact point or support point is formed axially between the wheel flange and the running ring. This creates a clearance between the wheel flange and the running ring over the entire radially aligned length of the running ring. This clearance can be used as a collecting space for contamination. In one embodiment, a sealing compound is additionally arranged between the (radially extending portion of) the wheel flange(s) and the running ring. This sealing compound is, for example, a rubber ring or a rubber coating. The sealing compound is axially upstream of the static sealing seat on the inner ring or on the (radially extending part of the) wheel flange(s), that is to say arranged on the side of the collecting space. In one embodiment, such a sealing compound is set up as a spacer in axial contact with the (radially extending portion of the) wheel flange(s). Alternatively, the sealing means is axially fixed due to a prestressing radially inward, for example in the manner of an O-ring, and supports an axial fixing of the running ring. Such a sealing means is preferably dispensed with in that the axially extending radial contact between the running ring and the inner ring or wheel flange, which forms the static sealing seat, has a sufficient sealing function. The collecting space is thus not limited by the running ring in the radial direction either outwards or inwards. The inward clearance, i.e., towards the axis of rotation of the wheel bearing arrangement, is preferably limited by an axial section of the wheel flange or by an axial extension of the inner ring. The running ring only limits the clearance in the axial direction. The collecting space formed in this way comprises a much larger holding volume than in previously known solutions. As a result of the larger collecting space, the bearing seal arrangement is better protected against the ingress of contaminants because the kinetic energy of the penetrating body is insufficient in most cases, for example as a result of a ricochet from a wall of the collecting space, to penetrate into the bearing inner chamber.

According to an advantageous embodiment of the wheel bearing arrangement, the running ring comprises the following components:

an axially aligned inner ring-side wall element for a static sealing seat;

an outer ring-side wall element aligned in the same axial direction as the inner ring-side wall element; and

a radially bridging wall element connecting the inner ring-side wall element and the outer ring-side wall element.

According to this embodiment, the C-shape is particularly simple, preferably formed with only three wall elements arranged at an angle to one another. This results in an annular shape for the running ring, which has an inner wall, that is to say the wall element on the inner ring side, and an outer wall, that is to say the wall element on the outer ring side, which extend axially, preferably flat and straight.

According to a preferred embodiment, the radially bridging wall element is oriented at a right angle to the inner ring-side wall element and/or to the outer ring-side wall element.

In one embodiment, the inner ring-side wall element and/or the outer ring-side wall element are shaped conically, that is to say inclined to the axis of rotation, as a result of which a targeted (into the bearing inner chamber) conveying of lubricant and/or (out into the collecting space and/or the environment) conveying of impurities can be achieved. Alternatively, the radially bridging wall element is arranged in a plane to which the axis of rotation is aligned normally. The inner ring-side wall element and/or the outer ring-side wall element are aligned to be parallel to the axis of rotation, that is to say formed as a surface of revolution. In such an embodiment, a particularly simple and therefore particularly precisely manufactured deep-drawing stamp or stamping punch is used for cold-forming production of the running ring from a metal sheet, preferably from a steel sheet. This results in the advantages of eliminating reworking steps with simultaneously a (one-step) push-on surface or press-on surface for forming an airtight static sealing seat with the inner ring.

According to an advantageous embodiment of the wheel bearing arrangement, the inner ring-side wall element comprises a first axial length and the outer ring-side wall element has a second axial length, the first length being longer than the second length.

In this embodiment it is achieved, on the one hand, that a long and therefore reliable, static sealing seat can be formed with the inner ring and, on the other hand, axial space for the sealing body is gained in the outer ring. Because the collecting space is axially upstream of the running ring, the radially bridging wall element acts as the main shielding surface for the at least one axially downstream sealing lip of the sealing body and the wall element on the outer ring side already reliably supports this shielding function when it is relatively short, i.e., shorter than the inner ring-side wall element. The radially bridging wall element of the running ring is preferably designed to be radially long, so that only a narrow gap is formed between the (axial) wall element of the sealing body arranged radially on the inside of the outer ring and the wall element of the running ring on the outer ring side. For example, this radial gap is designed in such a way that it is precisely ensured that no contact occurs between the running ring and the sealing body under any load conditions in accordance with the requirements.

According to an advantageous embodiment of the wheel bearing arrangement, the sealing body comprises two or more sealing lips made of an elastic material, the sealing lips projecting into an interior formed by the running ring.

At least one of the sealing lips is preferably brought into pressurized frictional contact with the running ring.

The sealing lips are designed for (permanent or sporadic) contact with the running ring for dynamic sealing. The first sealing lip at the rolling bodies is preferably axially directly inclined away from the sealing body towards the rolling bodies so that a self-seal is formed at liquid pressure from the bearing inner chamber, that is to say against lubricant leakage. According to one embodiment, the first sealing lip is prestressed in a sealing manner against the inner ring-side wall element of the running ring. As an alternative, the first sealing lip is made to measure with little play or exactly and is therefore not in contact with the corresponding sealing surface of the inner ring or the running ring, or only if it is tilted or deformed. If the sealing surface is formed on the running ring, axial installation space is gained and a shoulder with a surface suitable for sealing on the inner ring is not necessary.

The second sealing lip, which is arranged axially and/or radially further away from the rolling bodies than the first sealing lip, is preferably inclined away from the sealing body towards the collecting space, so that a self-sealing is formed through liquid pressure into the bearing inner chamber, i.e. against the influx of contaminants. The second sealing lip is preferably prestressed in a sealing manner against the radially bridging wall element of the running ring. As an alternative, the first sealing lip is made to measure with little play or exactly and is therefore not in contact with the corresponding sealing surface of the inner ring or the running ring, or only if it is tilted or deformed. For example, a grease reservoir is formed between the first sealing lip and the second sealing lip, which reduces the friction at the contact points and performs an additional sealing function against the penetration of lubricants or contaminants into the space between the first sealing lip and the second sealing lip.

This also enables a reduction of the prestressing force of the sealing lips, which is otherwise required for sealing, or prevents or reduces borrowing of the sealing lips into the corresponding sealing surface over the desired service life.

Sealing body a sealing bottom side, the sealing bottom side projecting from radially outside to radially inside partially overlaps the radial extent of the running ring.

As a result of this relative arrangement of the sealing body to the running ring, a gap with a zigzag course is formed, which extends the distance from the environment or the collecting space to the bearing inner chamber and thus makes it more difficult for contaminants to penetrate. The sealing body preferably overlaps the running ring radially so completely that on the rolling body side alone, a radial sealing lip of the sealing body forms a sealed gap with the running ring or with the inner ring.

According to an advantageous embodiment of the wheel bearing arrangement, the sealing body comprises an axial lip which is shaped in such a way that it forms a radial gap labyrinth seal with the wheel flange.

In this embodiment, the collecting space is largely covered radially on the outside by the axial lip. Only a sealingly contacting closed gap or a contact-free gap between the axial lip and the wheel flange forms a possible access for contaminants. The axial lip is preferably arranged radially outside the radial extension of the axial extension of the outer ring receiving the bearing seal arrangement, so that the collecting space is designed with a very large radial extension, for example larger than the radial extension of the extension of the bearing inner chamber receiving the bearing seal arrangement. For this purpose, the collecting space extends radially inside up to or further than the receiving surface for the running ring.

In a preferred embodiment, the axial lip furthermore forms a rear static sealing lip axially towards the outer ring, which forms an axially sealed closed gap on the outside of the outer ring or the axial extension thereof. This effectively prevents contaminants from penetrating into the contact area between the inside of the outer ring and the adjacent section of the sealing body. The latter contact area preferably forms the static main seal on the outer ring.

According to an advantageous embodiment of the wheel bearing arrangement, the sealing body comprises an axial wall element which is arranged at least partially axially overlapping with the axial extension of the running ring radially on the inside of the outer ring in such a way that the axial wall element and the running ring form an axial gap labyrinth seal.

As a result, a narrow axial gap can be formed between the running ring and the outer ring, which is suitable as an (axial gap) labyrinth seal. It is advantageous in the arrangement of the axial wall element that, in the case of an excessively large transverse load, direct contact between the running ring and the outer ring is prevented. The radial distance of the gap can thus be designed to be very small without fear of damage to the outer ring, even if the gap is deformed to such an extent that the running ring comes into contact with the axial wall element. The axial wall element is preferably designed with a rubber-elastic surface towards the running ring, so that no damage occurs to either of the two parts when there is contact between the running ring and the axial wall element. The sealing effect of the labyrinth seal is improved if the radial distance of the gap is very small.

According to an advantageous embodiment of the wheel bearing arrangement, the sealing body is supported on an inner side of the outer ring pointing in the direction of the inner ring.

This shape of the sealing body permits an axially short construction and at the same time a long zigzag distance with the running ring and/or sealing lips of the seal body which are well shielded by means of the running ring. This supporting surface preferably forms the static main seal on the outer ring side and, towards the running ring, the axial gap labyrinth seal as described above.

Furthermore, this creates a more robust seal on the outer ring to the environment, because if the outer ring is deformed, the sealing body is not expanded in the circumferential direction, rather is compressed, and when the outer ring returns to the desired shape thereof, the sealing body thereby is also forced to return to the desired shape thereof. Thus, the sealing function is guaranteed both during the presence of a deformation of the outer ring and again afterwards.

According to an advantageous embodiment of the wheel bearing arrangement, the sealing body comprises a collecting lip which projects from the open side into the axial extension of the running ring and comprises a radially outward curved and/or inclined shape.

The collecting lip forms a narrow radial and/or axial gap with the running ring at the projecting lip end thereof. The gap is preferably formed to bet contactless. The lip end preferably points from the radially inside toward the wall element on the outer ring side, so that the gap formed is axially aligned. Another labyrinth seal is thus formed. The collecting lip forms a collecting volume which is open radially and/or axially outwards and which is arranged in front of the at least one sealing lip from the surroundings to the rolling bodies. Collected particles and liquid then drip radially downwards or, in the case of a rotating sealing body, radially outwards during operation of the centrifugal force. If the shape of the seal body is suitably designed, the particles and fluid can even flow completely out of the bearing seal assembly following gravity or centrifugal force.

According to an advantageous embodiment of the wheel bearing arrangement, the outer ring comprises at least one projection and the sealing body has at least one corresponding recess, the projection engaging in the recess preventing circulation of the sealing body relative to the outer ring.

As a result, the mounting of the sealing body on the outer ring is improved in that a relative movement in the circumferential direction is prevented. Micromovements in the area of the outer ring can thus be reliably prevented. This means that not only is the material subject to less wear, but the sealing effect of the static sealing seat of the main seal on the outer ring is also improved because, as is otherwise the case with a micromovement, no lubricant and/or no contaminants can penetrate.

In one embodiment, the at least one protrusion penetrates the sealing body and forms a stop surface for the wheel flange to prevent damage to the bearing arrangement and/or downstream components in the event of extreme loads. In this case, a sealing material, for example rubber, preferably forms on each projection a surrounding pressed ring which forms a static seal with the outer ring.

### BRIEF DESCRIPTION OF THE DRAWINGS

The disclosure described above is explained in detail below based on the relevant technical background with reference to the associated drawings, which show preferred designs. The disclosure is in no way restricted by the purely schematic drawings, although it should be noted that the drawings are not dimensionally accurate and are not suitable for defining proportions. In the following

FIG. 1: shows a centrifugal plate according to the prior art;

FIG. 2: shows a C-shaped running ring;

FIG. 3: shows a sealing body with an axial wall element for internal contact in an outer ring;

FIG. 4: shows a section of a wheel bearing arrangement according to a first embodiment; and

FIG. 5: shows a section of a wheel bearing arrangement according to a second embodiment.

Unless explicitly stated otherwise, ordinal numbers used in the previous and subsequent descriptions are used only for the purposes of clear distinction and do not indicate the order or ranking of the designated components.

### DETAILED DESCRIPTION

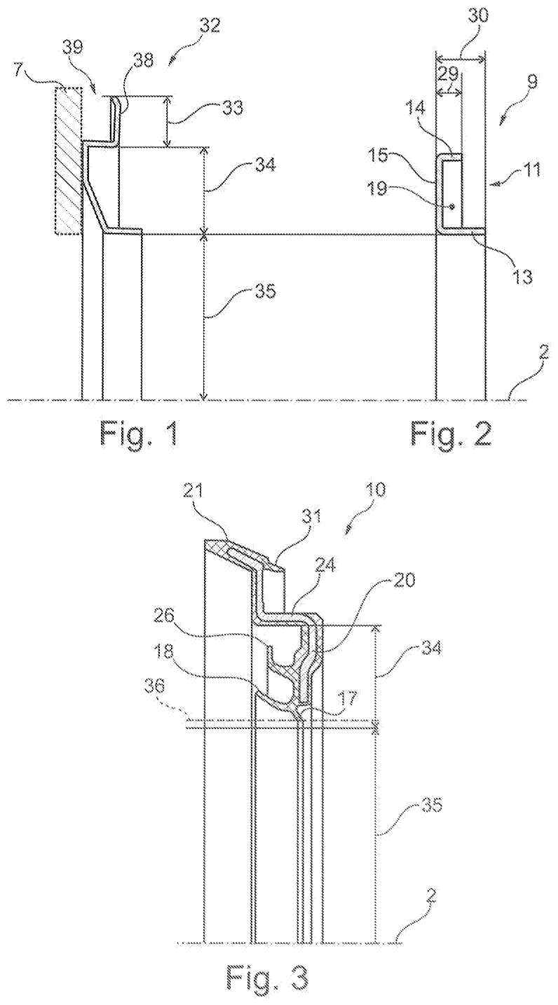

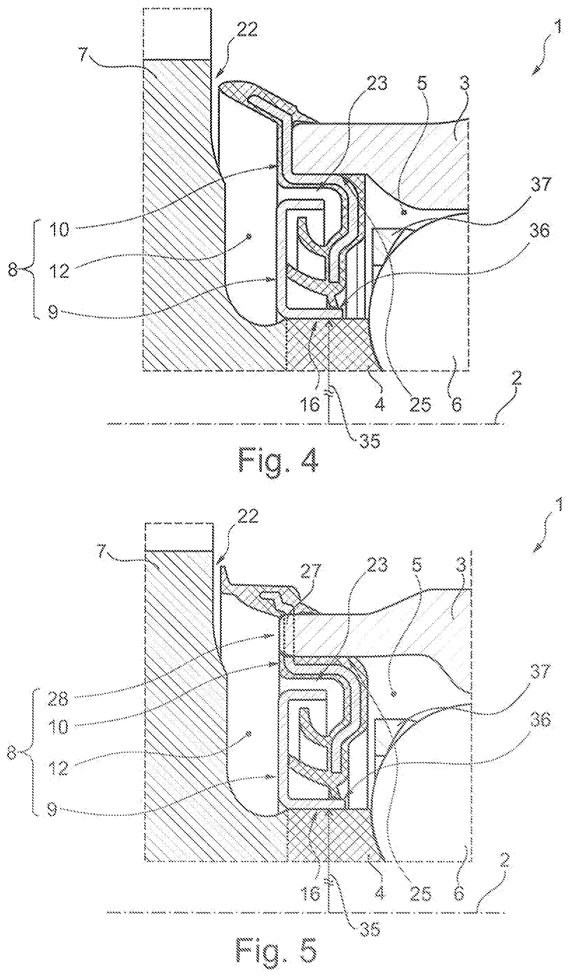

FIG. 1 shows a conventional centrifugal plate 32, as shown, for example, in FIG. 4 of DE 10 2013 218 635 A1. This is set up for axial contact with the wheel flange 7 (shown here purely schematically; compare FIG. 1 of DE 10 2013 218 635 A1). To form a conventional collecting space 39, a radial bracket 38 is formed, which together with the wheel flange 7 forms a comparatively small conventional collecting space 39.

FIG. 2 shows a preferred embodiment of a running ring 9 which replaces the conventional centrifugal plate 32. It can be seen here that a not inconsiderable material saving 33 has been achieved with the same radial gap height 34 and the same sealing seat radius 35. In addition, the shape is significantly simplified, so that the production is simplified and/or specified. The radial gap height 34 is here related to the remaining distance to the outer ring 3 or to the axial wall element 24 of the sealing body 10.

The running ring 9 is C-shaped with an open side 11 aligned with the rolling bodies 6 (see FIG. 4 or FIG. 5). In the C-shape shown, the running ring 9 comprises an axially aligned inner ring-side wall element 13, an outer ring-side wall element 14 arranged to be parallel to the inner ring-side wall element 13, and a radially bridging wall element 15 aligned in a plane perpendicular to the axis of rotation 2 which connects the inner ring-side wall element 13 and the outer ring-side wall element 14, and is arranged here at a right angle thereto. The wall elements 13, 14, 15 themselves are each designed to be straight and flat in the axial direction. A 90° bend is formed only in the transition area between the wall elements 13, 14, 15 arranged adjacent to one another. As a result of this simple form, production can be carried out particularly simply and precisely, for example by means of a deep-drawing process.

With the inner ring-side wall element 13, the running ring 9 is mounted on the inner ring 4 (compare FIG. 4 or FIG. 5), in that the inner ring-side wall element 13 lies flat on the inner ring 4 over the entire (first) axial length 29 thereof and is preferably pressed thereonto in a sealing manner. The inner ring-side wall element 13 comprises a (first) axial length 29 greater than the (shorter second) axial length 30 of the outer ring-side wall element 14. The outer ring-side wall element 14 is exposed and extends parallel to an inner side 25 of the outer ring 3, the outer ring-side wall element 14 being spaced apart from the inner side 25 of the outer ring 3. With the radially bridging wall element 15, the running ring 9 limits the clearance 12 in the axial direction. The radially bridging wall element 15 is arranged at a distance from the wheel flange 7.

The running ring 9 forms an interior 19 delimited by the three wall elements 13, 14, 15. In the embodiment shown in FIG. 4 and in FIG. 5, two sealing lips 17, 18 and a collecting lip 26 of the sealing body 10 protrude into this interior 19, so that these lips 17, 18, 26 protrude into the interior 19 from the rolling body-side open side 11 are protected by the wall elements 13, 14, 15 of the running ring 9.

FIG. 3 shows a sealing body 10 which, in interaction with the running ring 9 according to FIG. 2, as shown in FIG. 4, forms a very good sealing effect. The sealing body 10 here extends radially outward beyond the outer ring 3 (cf. FIG. 4 or FIG. 5), so that the sealing body 10 projects radially outward beyond the outer ring 3. The running ring 9 is also covered (almost completely) in the radial direction from a seal bottom side 20 of the seal body 10 over the radial gap height 34 (see FIG. 4 or FIG. 5). Radially outside of the outer ring 3, the sealing body 10 comprises an axial lip 21 which delimits the clearance 12 radially on the outside in the radial direction (see FIG. 4 or FIG. 5). The axial lip 21 here also comprises an axially rearward pre-lip 31, by means of which the static sealing seat, namely the inside 25 of the outer ring 3 (see FIG. 4 or FIG. 5), of the sealing body 10 is protected against the ingress of contaminants

The sealing body 10 shown here forms an axial gap labyrinth seal 23 (see FIG. 4 or FIG. 5) by means of an axial wall element 24 together with the wall element 14 of the running ring 9 on the outer ring side (see FIG. 2). In this way, for example, radial installation space is gained.

The first sealing lip 17, here ground down with a low (radial) prestressing, is supported on a radial sealing surface 36, for example the inner ring-side wall element 13 of the running ring 9, and is oriented radially inwards to the running ring 9. The second sealing lip 18 is supported here on the radially bridging wall element 15 of the running ring 9, ground down with a slight (axial) prestressing. The collecting lip 26 is spaced apart from the wall elements 13, 14, 15 of the running ring 9 (cf. FIG. 4 or FIG. 5) and forms a collecting volume that is open to the outlet, with an axial distance between the free end of the outer ring-side wall element 14 and the sealing body 10 being axially overlapped.

FIG. 4 shows a section of a wheel bearing arrangement 1 with an axis of rotation 2, for example for a motor vehicle (not shown here). This comprises an outer ring 3 and an inner ring 4 which can be rotated relatively thereto and is here integrally connected to a wheel flange 7. In the diagram, the inner ring 4 is set off from the rest of the wheel flange 7 by means of a crosshatching, but in the embodiment shown the inner ring 4 and the wheel flange 7 are formed in one piece. In an installed state, the outer ring 3 is connected, for example, to a wheel carrier (not shown here) or at least partially formed integrally therewith. Rolling bodies 6, here optionally with a bearing cage 37, are arranged between the outer ring 3 and the inner ring 4. The rolling bearing thus formed is, for example, an angular contact ball bearing, for example, a stressed bearing in an O arrangement.

The wheel bearing arrangement 1 comprises a bearing seal arrangement 8, the bearing seal arrangement 8 comprising, among other things, a running ring 9 designed as an outer seal. The running ring 9 is produced, for example, from a metal sheet by means of a, preferably one-step, stamping process.

The running ring 9 is positioned in the wheel bearing arrangement 1 such that the running ring 9 is only in contact with the inner ring 4. There is no contact between the running ring 9 and the outer ring 3 or with the wheel flange 7. The running ring 9 is supported on the surface of the inner ring 4 in the axial direction, here solely by means of the axial frictional force resulting from the pressing on. The running ring 9 forms a static sealing seat 16 with the sealing seat radius 35.

The running ring 9 is spaced from the wheel flange 7 in the axial direction, so that a clearance 12 is formed between the wheel flange 7 and the running ring 9 along the entire radially oriented length of the running ring 9. This clearance 12 forms a collecting space for collecting contaminants. In the axial direction, the clearance 12 is delimited on one side by the wheel flange 7 and on the other side by the running ring 9. A limitation of the clearance 12 is formed here radially inward by means of the wheel flange 7 or by means of the inner ring 4. A radially outward boundary is formed here by means of an axial lip 21 of the sealing body 10 of the bearing seal arrangement 8, which is formed by elastic material reinforced therewith.

The running ring 9 is arranged in an axially overlapping region with an extension of the outer ring 3, here optionally completely, or in an extension of the bearing inner chamber 5. The running ring 9 extends in the radial direction in a region between the outer ring 3 and the inner ring 4. The running ring 9 is spaced radially outward from the outer ring 3 or the sealing body 10 and forms there an axial gap labyrinth seal 23.

The sealing body 10 forms an input gap in the axial direction between the axial lip 21 thereof and the wheel bearing flange 7. Only through this entrance gap can contaminants enter the large clearance 12 and thus the collecting space. This inlet gap forms a radial gap labyrinth seal 22. FIG. 5 shows an embodiment of a wheel bearing arrangement 1 which, for the sake of clarity, corresponds to the wheel bearing arrangement 1 shown in FIG. 4. The only difference is that the sealing body 10 comprises a recess 28 into which is engaged a (here end-face) projection 27 of the outer ring 3, thus preventing the sealing body 10 from migrating around. Irrespective thereof, another variant of the axial lip 21 (see FIG. 3) in the radial gap labyrinth seal 22 is shown here.

The proposed wheel bearing arrangement creates an inexpensive and reliable seal.

### LIST OF REFERENCE SYMBOLS

1 Wheel bearing arrangement
2 Axis of rotation
3 Outer ring
4 Inner ring
5 Bearing inner chamber
6 Rolling bodies
7 Wheel flange
8 Bearing seal arrangement
9 Running ring
10 Sealing body
11 Open side
12 Clearance
13 Inner ring-side wall element
14 Outer ring-side wall element
15 Radially bridging wall element
16 Static sealing seat
17 First sealing lip
18 Second sealing lip
19 Interior
20 Seal bottom side
21 Axial lip
22 Radial gap labyrinth seal
23 Axial gap labyrinth seal
24 Axial wall element
25 Inner side
26 Collecting lip
27 Projection
28 Recess
29 First axial length
30 Second axial length
31 Pre-lip
32 Conventional centrifugal plate
33 Material savings
34 Radial gap height
35 Sealing seat radius
36 Radial sealing surface
37 Bearing cage

1. A wheel bearing arrangement with an axis of rotation, comprising:
an outer ring;
an inner ring which can be rotated about the rotational axis relative to the outer ring, a bearing inner chamber being formed between the outer ring and the inner ring, in which rolling bodies are arranged such that they can roll;
a wheel flange which is connected fixedly to the inner ring, wherein the wheel flange is overlapping the bearing inner chamber radially; and
a bearing seal arrangement which comprises a running ring which is configured as an outer seal, and a seal body designed as a main seal, the running ring being supported on the inner ring and the seal body being supported on the outer ring, the running ring being C-shaped in cross-section with a radial and axial extent with a side which is open towards the rolling bodies, wherein the running ring is arranged radially and axially spaced apart from the wheel flange with the result that a clearance formed between the wheel flange and the running ring is configured along the radial extent of the running ring, the clearance configuring a collection chamber;
wherein the sealing body comprises an axial lip which is shaped in such a way that with the wheel flange forms a
radial gap labyrinth seal and the sealing body comprises an axial wall element which is arranged radially on the inside of the outer ring at least partially axially overlapping with the axial extension of the running ring such that the axial wall element and the running ring form an axial gap labyrinth seal.

2. The wheel bearing assembly of claim 1, wherein the running ring comprises:
an axially aligned inner ring-side wall element for a static sealing seat;
an outer ring-side wall element aligned in the same axial direction as the inner ring-side wall element; and
a radially bridging wall element, connecting the inner ring-side wall element and the outer ring-side wall element, which is oriented at a right angle to either or both of the inner ring-side wall element and the outer ring-side wall element.

3. The wheel bearing arrangement of claim 2, wherein the inner ring-side wall element has a first axial length and the outer ring-side wall element comprises a second axial length the first length being longer than the second length.

4. The wheel bearing arrangement (1) of claim 1, wherein the sealing body comprises two or more sealing lips formed from an elastic material, wherein the sealing lips protrude into an interior formed by the running ring and are brought into pressurized frictional contact with the running ring.

5. The wheel bearing arrangement of claim 1, wherein the sealing body, comprises a sealing bottom side, wherein the sealing bottom side is projecting from radially outside to radially inside which partially overlaps the radial extent of the running ring.

6. The wheel bearing arrangement of claim 1, wherein the sealing body is arranged to be supported on an inner side of the outer ring pointing in the direction of the inner ring.

7. The wheel bearing arrangement of claim 1, wherein the sealing body comprises a collecting lip which protrudes from the open side into the axial extension of the running ring and has a radially outwardly curved and/or an inclined shape.

8. The wheel bearing arrangement of claim 1, wherein the outer ring comprises at least one projection and the sealing body comprises at least one corresponding recess, the projection engaging in the recess preventing movement of the sealing body relative to the outer ring.
